(19) United States
(12) Patent Application Publication
(10) Pub. No.: US 2025/0149203 A1
(43) Pub. Date: May 8, 2025

(54) COMMUNICATION LINE AND COMMUNICATION SYSTEM USING THE SAME

(71) Applicant: UNIQCONN INC., Seongnam-si (KR)

(72) Inventors: Young Dong KIM, Hwaseong-si (KR); Yong Hun OH, Pyeongtaek-si (KR); Joung Min PARK, Osan-si (KR); Gi Yun UM, Seongnam-si (KR)

(73) Assignee: UNIQCONN INC., Seongnam-si (KR)

(21) Appl. No.: 18/928,911

(22) Filed: Oct. 28, 2024

(30) Foreign Application Priority Data
Nov. 6, 2023 (KR) 10-2023-0151852

(51) Int. Cl. H01B 7/17

(52) U.S. Cl. CPC H01B 7/17

(57) ABSTRACT

The present disclosure relates to a communication line and a communication system using the same. The communication line according to an embodiment of the present disclosure includes a core portion that extends in a longitudinal direction and has a circular cross section, one or more ribs formed to extend from an outer surface of the core portion, a shielding portion that is connected to the rib, is formed to surround the core portion, and has at least one slit formed in the longitudinal direction, and a cover portion configured to cover the slit.

### CROSS-REFERENCE TO RELATED APPLICATION

This application claims priority to and the benefit of Korean Patent Application No. 10-2023-0151852, filed on Nov. 6, 2023, the disclosure of which is incorporated herein by reference in its entirety.

### BACKGROUND

### 1. Field of the Invention

The present disclosure relates to a communication line and a communication system using the same, and more particularly, to a communication line for signal transmission and a communication system using the same.

### 2. Discussion of Related Art

Communication lines made of dielectrics have a lower manufacturing cost than conductor-based communication lines have and their installation and management are easier than those of optical-based communication lines, and accordingly, the communication lines may be efficiently utilized in chip-to-chip communications.

Meanwhile, when dust or foreign matter comes into contact with a portion of a communication line, through which a signal is transmitted, the quality of high-frequency signals may be degraded or signal loss may be increased. However, conventional communication lines have a problem in that external dust or foreign matter is attached to the communication lines, which degrades the quality of signals transmitted through the communication lines or increases signal loss.

Further, the conventional communication lines have a problem in that excessive force is exerted to bend the communication lines and a gap through which external dust or foreign matter enters an inside of the communication line is formed when the communication lines are bent.

Further, the conventional communication lines have a problem in that an amount of the outside leakage of signals propagating through the conventional communication lines is excessive. Accordingly, the signals propagating through the conventional communication lines become incomplete, and as the length of the communication line increases, the attenuation of the signal may increase, cumulative signal loss may increase, and noise may be generated in electronic devices around the communication line.

Meanwhile, the related art described above is technical information that the inventor possessed for deriving the present disclosure or acquired during the process of deriving the present disclosure, and cannot necessarily be considered as publicly known technology disclosed to the general public prior to the application of the present disclosure.

### RELATED ART DOCUMENT

### Patent Document

(Patent Document 1) Korean Laid-open Patent Publication No. 10-2010-0032769 (Mar. 26, 2010)

### SUMMARY OF THE INVENTION

The present disclosure is directed to providing a communication line capable of preventing a problem such as signal quality degradation or increased signal loss rate by preventing external dust or foreign matter from being attached to a portion through which a signal is transmitted.

The present disclosure is also directed to providing a communication line capable of being easily bent, and capable of easily connecting devices to each other even in a narrow or complex space.

The present disclosure is also directed to providing a communication line capable of preventing a problem such as signal quality degradation or increased signal loss rate by preventing the formation of a gap through which dust or foreign matter can enter an inside of the communication line even when the communication line is bent.

The present disclosure is also directed to providing a communication line or a communication system, which is capable of significantly reducing an electromagnetic field leaking to the outside.

Objects of the present disclosure are not limited to the above-described object and other objects that are not described may be clearly understood by those skilled in the art from the following descriptions.

According to an aspect of the present disclosure, there is provided a communication line which includes a core portion that extends in a longitudinal direction and has a circular cross section, one or more ribs formed to extend from an outer surface of the core portion, a shielding portion that is connected to the rib, is formed to surround the core portion, and has at least one slit formed in the longitudinal direction, and a cover portion configured to cover the slit.

The cover portion may be disposed to be spaced apart from the slit on an outer side of the shielding portion.

The shielding portion may include a wing portion formed to extend in a circumferential direction of the core portion from at least one of the ribs, and a portion of the cover portion may be disposed to overlap a portion of the wing portion in a radial direction of the core portion.

The wing portion may be formed to extend in both side directions from the rib, and both ends of the wing portion may be spaced apart from each other to form a slit.

One end of the wing portion formed to extend from any one of the ribs and one end of the wing portion formed to extend from an adjacent rib may be spaced apart from each other to form a slit.

The cover portion may protrude from a portion of the wing portion, cover an adjacent slit, and extend while being bent.

The ribs may include a first rib from which the wing portion is formed and a second rib from which the cover portion is disposed.

The second rib may protrude to pass through the slit, and the cover portion may be formed to extend from an end portion of the second rib.

A sum of a length from the second rib to one side end portion of the cover portion and a thickness of the second rib may be greater than a width of the slit.

The cover portion may be detachably connected to the second rib.

A head portion having a thickness greater than a thickness of the second rib may be formed at an end portion of the second rib, a coupling portion for coupling with the head portion may be formed on the cover portion, and the coupling portion may include an accommodation space in which the head portion is accommodated when the coupling portion is coupled to the second rib, and two fixing portions each having protrusions formed in directions facing each other to fix the accommodated head portion.

The cover portion may be slid in the longitudinal direction and coupled to the second rib while the head portion is accommodated in the accommodation space and fixed by the two fixing portions.

Inclined surfaces may be formed at both sides of the head portion, each of the two fixing portions may be elastically deformed in opposite directions by the inclined surfaces when the head portion is inserted toward the accommodation space, and the cover portion may be coupled to the second rib as each of the two fixing portions is elastically recovered.

The core portion, the rib, the shielding portion and the cover portion may be formed to extend in the same direction and may be made of the same flexible dielectric material.

According to another aspect of the present disclosure, there is provided a communication system which includes the communication line according to an embodiment of the present disclosure, and a transmitter configured to output an electromagnetic wave signal toward the communication line.

In the communication system, the communication line may be installed such that a direction in which ribs extend from a core portion is misaligned with a horizontal polarization direction or a vertical polarization direction of an electromagnetic wave signal so that the electromagnetic wave signal does not leak to an outside of the communication line.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a communication line according to an embodiment of the present disclosure;

FIG. 2 is a cross-sectional view of the communication line in a direction perpendicular to a longitudinal direction according to an embodiment of the present disclosure;

FIG. 3 is a cross-sectional view of a communication line in a direction perpendicular to a longitudinal direction according to another embodiment of the present disclosure;

FIG. 4 is a cross-sectional view of a communication line in a direction perpendicular to a longitudinal direction according to still another embodiment of the present disclosure;

FIG. 5 is a cross-sectional view of a communication line in a direction perpendicular to a longitudinal direction according to yet another embodiment of the present disclosure;

FIG. 6 is a cross-sectional view of a communication line in a direction perpendicular to a longitudinal direction according to yet another embodiment of the present disclosure;

FIG. 7 is a view for describing a cover portion of the communication line of FIG. 6 that is slid in the longitudinal direction and coupled to a second rib;

FIG. 8 is a view for describing the cover portion of the communication line of FIG. 6 that is inserted from an outer side of a shielding portion and coupled to the second rib;

FIG. 9 is a cross-sectional view of a communication line in a direction perpendicular to a longitudinal direction according to yet another embodiment of the present disclosure; and

FIG. 10 is a view for describing a communication system using a communication line according to an embodiment of the present disclosure.

### DETAILED DESCRIPTION OF EXEMPLARY EMBODIMENTS

Advantages and features of the present disclosure and methods of achieving the same will be clearly understood with reference to the accompanying drawings and embodiments described in detail below. However, the present disclosure is not limited to the embodiments disclosed below, but may be implemented in various different forms. The embodiments are provided in order to fully explain the present disclosure and fully explain the scope of the present disclosure for those skilled in the art. That is, the scope of the present embodiments is only defined by the appended claims.

The shapes, sizes, ratios, angles, or numbers disclosed in the drawings for describing the embodiments of the present disclosure are exemplary, and therefore, the present disclosure is not limited to the matters illustrated. Further, in description of the present disclosure, when it is determined that detailed descriptions of related well-known functions or configurations may unnecessarily obscure the gist of the present disclosure, detailed descriptions thereof will be omitted. Further, when the terms “include,” “have,” “consist of,” etc., are used in this specification, another portion may be added unless “only” is used. When a component is expressed in the singular form, it includes a case where it includes a plural form unless the context clearly indicates otherwise.

In interpretation of components, it is interpreted as including a range of errors even when there is no separate explicit description. For example, unless otherwise explicitly stated, the term “same” does not mean exactly the same, but rather “substantially the same” within a range of error that those skilled in the art may reasonably expect to encounter in practicing the present disclosure.

It should be understood that, although the terms “first,” “second,” etc., may be used herein to describe various components, these components are not limited by these terms. The terms are only used to distinguish one component from another component. Therefore, it should be understood that a first component to be described below may be a second component within the technical scope of the present disclosure.

Unless otherwise specified, like reference numerals refer to like elements throughout the specification.

The individual features of the various embodiments of the present disclosure may be partially or wholly combined or combined with each other, and as can be fully understood by those skilled in the art, various technical connections and operations are possible, and each embodiment may be implemented independently of each other or may be implemented together in a related relationship.

In the present disclosure, when a plurality of components are connected, it should be understood that the respective components may be connected not only directly to each other, but also indirectly. Therefore, when the plurality of components are connected to each other, another component may be connected between the plurality of components.

In description of various embodiments of the present disclosure, when some configuration of an embodiment is substantially the same as or corresponding to some configuration of another embodiment described above, the description of that configuration may be omitted for a clear and concise description of the present disclosure. Further, when some configurations have a structure that is symmetrical with other configurations, for example, a structure with axial symmetry or rotational symmetry, so that both configurations are substantially the same configuration with only a difference in direction or location, the description of the configuration may be omitted for the sake of a clear and concise description of the present disclosure, unless it is necessary to specify the present disclosure.

Hereinafter, the present disclosure will be described in detail with reference to the accompanying drawings.

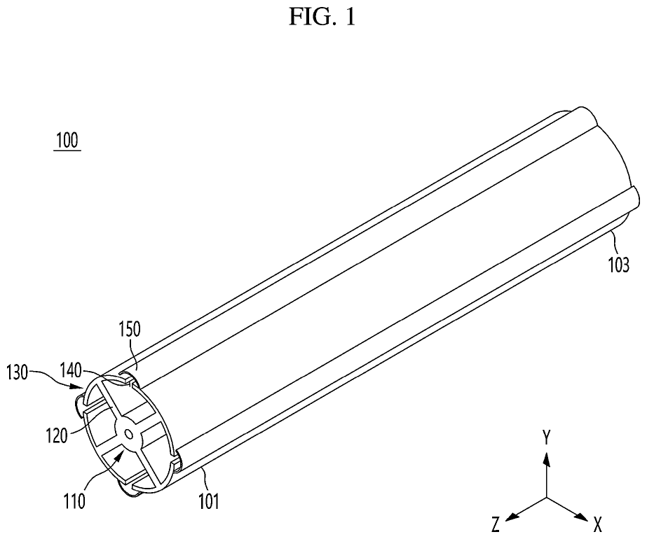

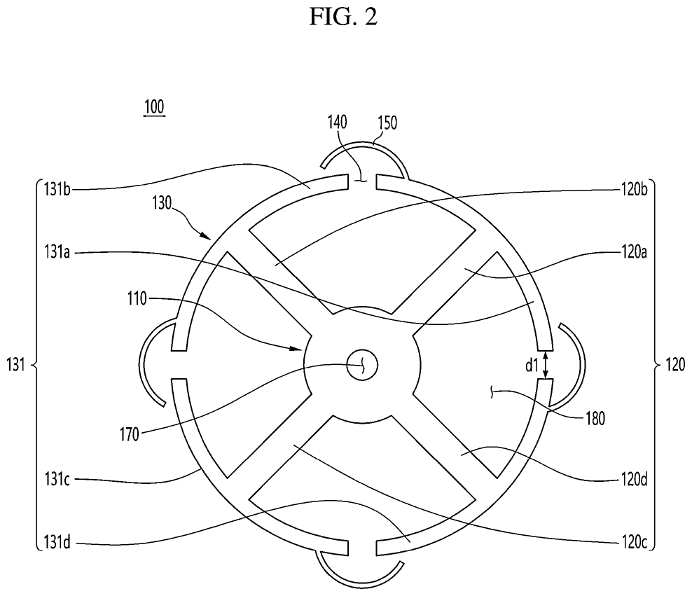

FIG. 1 is a perspective view of a communication line according to an embodiment of the present disclosure. FIG. 2 is a cross-sectional view of the communication line in a direction perpendicular to a longitudinal direction according to an embodiment of the present disclosure.

First, referring to FIG. 1, a communication line 100 includes a core portion 110 that extends in the longitudinal direction and has a circular cross section, one or more ribs 120 formed to extend from an outer surface of the core portion 110, a shielding portion 130 that is connected to the rib 120, is formed to surround the core portion 110, and has at least one slit 140 formed in the longitudinal direction, and a cover portion 150 for covering the slit 140. Here, the longitudinal direction may be a Z-axis direction illustrated in FIG. 1.

According to the embodiment of the present disclosure, the communication line 100 may perform bidirectional signal transmission. For example, referring to FIG. 1, the communication line 100 may transmit a signal from one end 101 to the other end 103, as well as transmit a signal from the other end 103 to the one end 101.

According to the embodiment of the present disclosure, the core portion 110, the ribs 120, the shielding portion 130, and the cover portion 150 may be made of a dielectric material. In the present disclosure, the dielectric material may be a material having permittivity. The permittivity is a value for the effect of a medium between charges on an electric field when the electric field acts between the charges, and depends on the frequency of an electromagnetic wave signal propagating in a dielectric. Further, when an electromagnetic wave signal propagates toward a boundary between materials having different permittivities, the electromagnetic wave signal may be adjusted to be totally reflected at the boundary between the two materials by adjusting permittivity of each of the two materials, a signal incident angle or a frequency of the signal. That is, the electromagnetic wave signal may propagate along a dielectric material.

Further, the signal received at the one end 101 of the communication line 100 according to the embodiment of the present disclosure may be an electromagnetic wave signal. Accordingly, due to the properties of the above-described dielectric, the electromagnetic wave signal may be transmitted to the other end 103 in a longitudinal direction of the core portion 110 through the dielectric material.

Further, in the communication line 100 according to the embodiment of the present disclosure, the core portion 110, the ribs 120, the shielding portion 130, and the cover portion 150 may be formed to extend in the same direction. Accordingly, the communication line 100 may be manufactured by an injection molding process, and thus the manufacturing time and cost can be reduced.

Meanwhile, in the communication line 100 according to the embodiment of the present disclosure, the core portion 110, the ribs 120, the shielding portion 130, and the cover portion 150 may be made of the same dielectric material. In this case, since the permittivity is the same in all portions of the communication line according to the embodiment of the present disclosure, the frequency of the signal may be easily adjusted so that the signal transmitted through the core portion does not leak to the outside. Further, the communication line 100 may be manufactured by a compression molding process, an extrusion molding process, or an injection molding process, and thus the manufacturing time and cost can be reduced.

Further, in the communication line 100 according to the embodiment of the present disclosure, the core portion 110, the ribs 120, the shielding portion 130, and the cover portion 150 may be made of a flexible material. In this case, the communication line may be easily bent, and may be changed to have various shapes to connect chips and chips even in a narrow space. In addition, when a central hole is formed inside the core portion as described above, the communication line can be more easily bent.

Referring to FIGS. 1 and 2, the core portion 110 may be made of a dielectric material having a higher permittivity than the air has. Further, an air layer 180 may be formed between the ribs 120. Accordingly, due to the properties of the above-described dielectric, the core portion 110 may transmit the electromagnetic wave signal received at the one end 101 of the communication line 100 to the other end 103, and the electromagnetic wave signal may be totally reflected inside the core portion 110 and may not leak through the air layer 180. Accordingly, the communication line 100 may transmit the electromagnetic wave signal with a low loss rate.

Meanwhile, referring to FIGS. 1 and 2, a central hole 170 may be formed inside the core portion 110. Further, the outer surface of the core portion 110 and the central hole 170 may extend in the longitudinal direction while having a circular shape. Furthermore, as illustrated in FIG. 2, the core portion 110 and the central hole 170 may share a central axis. However, the shapes and locations of the core portion 110 and the central hole 170 are not limited thereto. For example, a cross-section of the central hole 170 in a direction perpendicular to a longitudinal direction may have a polygonal shape and may be formed at a location outside the central axis of the core portion 110. When the central hole 170 is formed in the core portion 110 in this way, the force exerted to bend the core portion 110 may be reduced. Accordingly, since the communication line 100 is easy to bend, the communication line 100 may be installed in various forms even in a narrow or complex space.

Meanwhile, the shielding portion 130 according to the embodiment of the present disclosure may protect the core portion 110 through which the signal is transmitted, from the outside of the communication line 100. Further, the rib 120 may support the shielding portion 130.

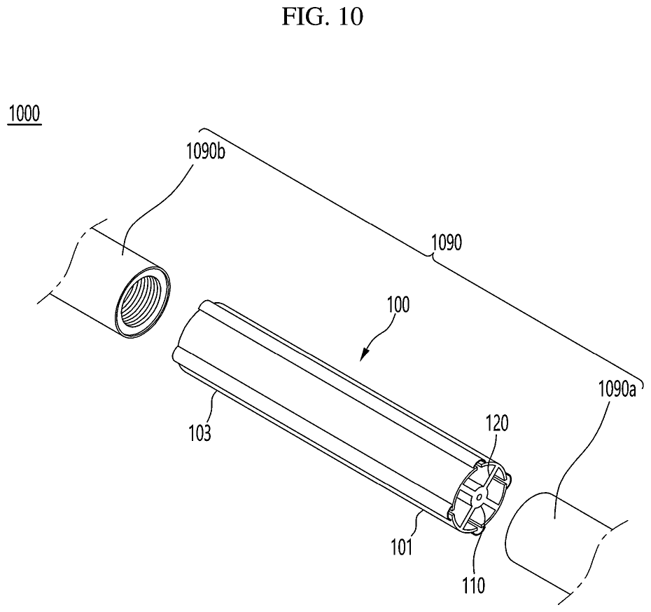

The rib 120 according to the embodiment of the present disclosure may be formed in a straight line in a radial direction of the core portion 110. Here, the radial direction of the core portion 110 may be a direction radially outward from the center of the core portion 110. Meanwhile, when an electromagnetic wave signal propagates, an electromagnetic field oscillates on a plane perpendicular to a direction of propagation of the electromagnetic wave. For example, when the electromagnetic wave signal propagates, a horizontally polarized wave and a vertically polarized wave may be generated. When the rib 120 extends in a straight line in the radial direction of the core portion 110 and the extension direction of the rib 120 is misaligned with the polarization direction of an electromagnetic wave signal radiated from a transmitter, a phenomenon of the electromagnetic field being emitted to the outside from the communication line 100 may be alleviated. This embodiment will be described below with reference to FIG. 10.

The rib 120 according to the embodiment of the present disclosure may be provided as a plurality of ribs 120. For example, referring to FIG. 2, the ribs 120 may include a first rib 120a, a second rib 120b adjacent to the first rib 120a, a third rib 120c adjacent to the second rib 120b, and a fourth rib 120d adjacent to the third rib 120c. When the plurality of ribs 120 are provided as described above, the shielding portion 130 becomes more reenforced, and thus the durability of the communication line 100 against external impact or bending can be improved.

Further, referring to FIG. 2, the plurality of ribs 120a, 120b, 120c, and 120d may be disposed to be spaced an equal interval from each other. When the ribs 120 are disposed to be spaced an equal interval from each other, it can be easier to bend the communication line 100. For example, when four ribs 120 are disposed to be spaced an equal interval from each other as described in FIG. 2, the communication line 100 may be easily bent up and down and left and right.

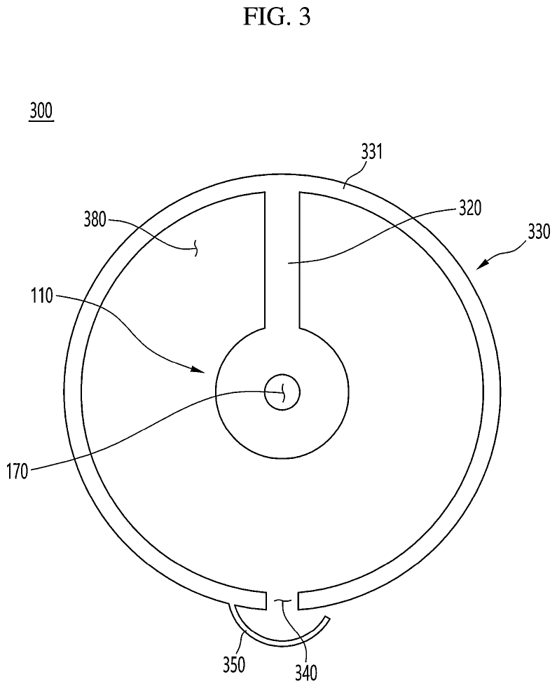

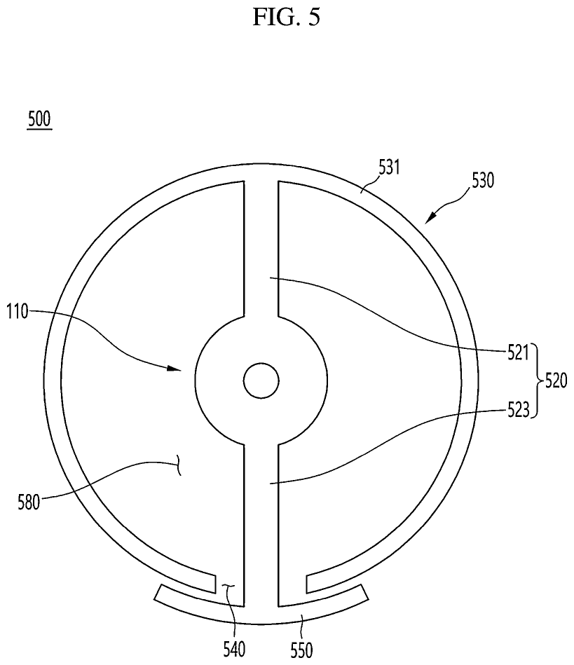

However, the number of ribs 120 is not limited. For example, the number of ribs 120 may be two. For another example, the number of ribs 120 may be one. When the number of ribs 120 is reduced in this way, the amount of electromagnetic wave signals that are transmitted through the core portion 110 and emitted through the ribs 120 is reduced, and thus the signal transmission efficiency of the communication line 100 can be improved. An example in which the number of ribs 120 is one will be described below with reference to FIG. 3, and an example in which the number of ribs 120 is two will be described below with reference to FIG. 5.

Meanwhile, the shielding portion 130 according to the embodiment of the present disclosure may be configured to protect the core portion 110 through which the signal is transmitted. That is, the shielding portion 130 may protect the core portion 110 by preventing an impact from the outside of the communication line 100 from being transmitted to the core portion 110 or preventing dust or foreign matter outside the communication line 100 from being attached to the outer surface of the core portion 110. Accordingly, the shielding portion 130 may prevent the quality of the signal transmitted through the core portion 110 from being degraded.

Referring to FIGS. 1 and 2, the cover portion 150 may be disposed on an outer side of the shielding portion 130. Further, the cover portion 150 may be disposed to be spaced apart from the slit 140. When the communication line 100 is bent, the shape of the slit 140 may be changed. For example, when the communication line 100 is bent to one side, the width of the slit 140 disposed inside the communication line 100 in the bending direction may be narrowed, and the width of the slit 140 disposed outside the communication line 100 in the bending direction may be widened. According to the above-described embodiment, the cover portion 150 does not interfere with the deformation of the slit 140, so that the ease of bending of the communication line 100 is maintained, while preventing dust or foreign matter outside the communication line 100 from entering the inside of the communication line 100.

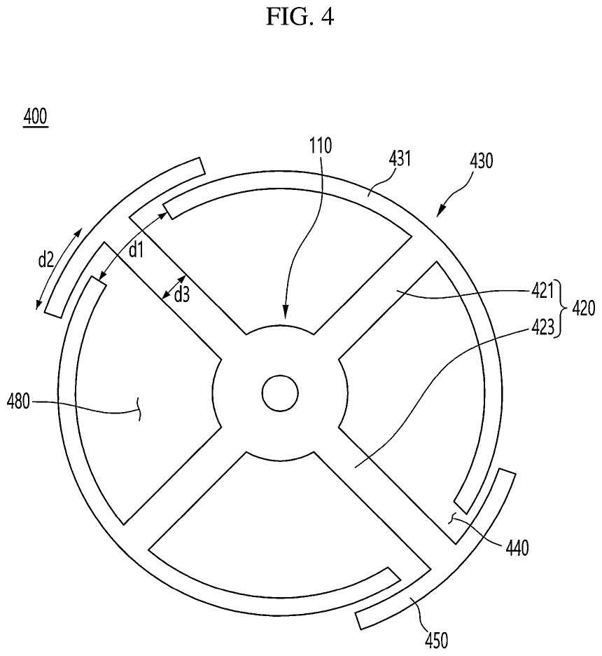

Meanwhile, referring to FIGS. 1 and 2, the shielding portion 130 may include a wing portion 131 formed to extend in a circumferential direction of the core portion 110 from at least one of the ribs 120. The wing portion 131 according to the embodiment of the present disclosure may be formed from at least one of the ribs 120. For example, as disclosed in FIG. 2, the wing portion 131 may be formed from each of the plurality of ribs 120a, 120b, 120c, and 120d. In this case, since one wing portion 131 is supported by one rib 120, the wing portion 131 may be more reenforced. However, the wing portion 131 may be formed only in some ribs 120 and not in other ribs. This will be described below with reference to FIGS. 4 to 9.

Referring to FIGS. 1 and 2, the wing portion 131 may be formed to extend in the circumferential direction of the core portion 110. For example, as illustrated in FIG. 2, the core portion 110 and the wing portion 131 may each have a concentric circle shape. Accordingly, a distance between any one portion of the wing portion 131 and the outer surface of the core portion 110 may be constant. As described above, the signal transmitted through the core portion 110 may leak an electromagnetic wave to the outside. In addition, the electromagnetic wave leaked to the outside of the core portion 110 may have a specific wavelength depending on the wavelength of the signal transmitted through the core portion 110. Therefore, when the wing portion 131 is formed in the circumferential direction of the core portion 110 at a distance where the intensity of the electromagnetic field leaked from the core portion 110 is weak, the wing portion 131 may protect the core portion 110 and prevent the electromagnetic wave leaked from the core portion 110 from leaking out of the communication line 100 through the dielectric material of the wing portion 131.

Meanwhile, in FIG. 2, although the wing portion 131 is illustrated as being formed to extend in both side directions from a distal end portion of the rib 120, the formation location and extension direction of the wing portion 131 are not limited thereto. For example, the wing portion 131 may extend from the middle of the rib 120 (not illustrated), and may extend in one side direction rather than both side directions (not illustrated).

Further, the wing portion 131 according to the embodiment of the present disclosure may be provided as a plurality of wing portions 131. For example, as disclosed in FIG. 2, the wing portions 131 may include four wing portions 131a, 131b, 131c, and 131d. However, the number of wing portions 131 is not limited thereto. For example, as disclosed in FIG. 3, the number of wing portions 331 may be one. FIG. 3 will be described below.

Further, referring to FIGS. 1 and 2, the wing portions 131 may be formed to extend in both side directions from the rib 121. That is, the wing portions 131 may be formed to extend from the rib 121 in the circumferential direction of the core portion 110 at both sides.

Meanwhile, as disclosed in FIG. 2, a portion of the cover portion 150 may be disposed to overlap a portion of the wing portion 131 in the radial direction of the core portion 110. That is, in the radial direction of the core portion 110, the wing portion 131 and the cover portion 150 may be present simultaneously. In this case, even when the communication line 100 is bent and the width of the slit 140 is increased, the cover portion 150 may cover the slit 140 and block the entering of external dust.

According to the embodiment of the present disclosure, the slit 140 may be a gap that thinly extends in the longitudinal direction of the core portion 110. Further, the slit 140 may be a space formed from an end portion of the wing portion 131 to an adjacent end portion. For example, as disclosed in FIG. 2, when the wing portion 131 is provided as a plurality of wing portions 131, one end of a wing portion 131a formed to extend from any one rib 120a of the ribs 120 and one end of a wing portion 131b formed to extend from an adjacent rib 120b may be spaced apart from each other to form the slit 140. That is, the slit 140 having a width dl may be formed between one side end portion and the other side end portion of each of the plurality of wing portions 131a, 131b, 131c, and 131d.

As described above, the communication line 100 is made of a flexible dielectric material and the slit 140 is formed in the communication line 100, and thus the slit 140 is deformed and recovery elastic force generated in the shielding portion 130 may be greatly alleviated when the communication line 100 is bent. Accordingly, since the communication line 100 is more easily bent, the communication line 100 may be easily installed even in a narrow or complex space. Meanwhile, even when there is only one wing portion 131, both ends of the wing portion 131 may be spaced apart from each other to form the slit 140. This will be described below with reference to FIG. 3.

As described above, when the slit 140 is formed in the communication line 100, the communication line 100 may be more easily bent, but dust or foreign matter outside the communication line 100 may pass through the slit 140 and the air layer 180 and may be attached to the outer surface of the core portion 110. In this case, the quality of the signal transmitted through the core portion 110 may be reduced, or the signal may be lost as the length of the communication line 100 increases. However, according to the embodiment of the present disclosure, since the cover portion 150 covers the slit 140, it is possible to prevent a problem in that dust or foreign matter outside the communication line 100 enters through the slit 140. Hereinafter, cover portions according to various embodiments of the present disclosure will be described.

Referring to FIGS. 1 and 2, the cover portion 150 may protrude from a portion of the wing portion 131, cover an adjacent slit 140, and extend while being bent. In this case, since the cover portion 150 is supported by only one contact point with the wing portion 131, the communication line 100 may be bent more easily.

Further, referring to FIG. 2, each slit 140 may be formed in the middle of adjacent ribs 120. Accordingly, each slit 140 may be formed to be spaced apart from the rib 120 as much as possible. Since the rib 120 is formed to have a certain thickness or more to support the wing portion 131, the rib 120 has strong bending strength. As described above, when the slit 140 is formed to be spaced apart from the rib as much as possible, the communication line 100 may be more easily bent up, down, left, and right.

Further, as illustrated in FIG. 2, when the distances between each of the plurality of rib 120 and each of the plurality of slit 140 are the same, the communication line 100 may have a rotationally symmetrical shape, and thus the communication line 100 may be structurally stable and may be easily installed in a communication system.

Meanwhile, in FIGS. 1 and 2, although the rib 120, the wing portion 131, and the cover portion 150 are illustrated as being provided as a plurality of the rib 120, a plurality of wing portions 131 and a plurality of cover portions 150, respectively, one rib 120, one wing portion 131, and one cover portion 150 may be formed. This will be described with reference to FIG. 3.

FIG. 3 is a cross-sectional view of a communication line in a direction perpendicular to a longitudinal direction according to another embodiment of the present disclosure.

Referring to FIG. 3, a communication line 300 may include a core portion 110, one rib 320, one wing portion 331, and one cover portion 350. In this case, both ends of the wing portion 331 may be spaced apart from each other to form a slit 340. According to the above-described embodiment, since there are one rib 320, one wing portion 331, and one cover portion 350, the communication line 300 has a simple structure, and thus the manufacturing time and cost can be reduced and the communication line 300 can be more easily bent.

Further, as described above, since an electromagnetic wave signal transmitted through the core portion 110 propagates along a dielectric material, the thicker or more numerous the ribs 320 are formed, the more the electromagnetic wave leaked from the core portion 110 may be strengthened. However, as illustrated in FIG. 3, when there is one rib 320, a dielectric material connected to the core portion 110 is reduced and a region of an air layer 380 is expanded, and thus the electromagnetic wave leaked from the core portion 110 may be weakened.

Further, as illustrated in FIG. 3, the slit 340 may be formed at an opposite side of a portion of the rib 320, from which the wing portions 331 extend. That is, the portion, from which the wing portions 331 extend, and the slit 340 may be present at opposite sides with respect to the core portion 110. Accordingly, the slit 340 may be formed to be spaced apart from the rib 320 as much as possible. When the slit 340 is formed to be spaced apart from the rib 320 with strong bending strength as much as possible, the communication line 300 may be more easily bent left and right.

FIG. 4 is a cross-sectional view of a communication line in a direction perpendicular to a longitudinal direction according to still another embodiment of the present disclosure.

According to the embodiment of the present disclosure, ribs 420 may include a first rib 421 in which a wing portion 431 is formed and a second rib 423 in which a cover portion 450 is disposed. For example, referring to FIG. 4, only the wing portion 431 is formed on the first rib 421, and the cover portion 450 may be disposed on the second rib 423. As described above, when the ribs 420 are divided into the first rib 421 in which the wing portion 431 is formed and the second rib 423 in which the cover portion 450 is disposed, the thickness or shape of each of the ribs 420 may be changed depending on the functions of the wing portion 431 and the cover portion 450.

Further, referring to FIG. 4, the second rib 423 may protrude to pass through a slit 440. In this case, the second rib 423 may extend to be longer than the first rib 421 does to protrude further than the wing portion 431. According to the above-described embodiment, since the portion of the second rib 423 is located in the slit 440, a range of shaking of the second rib 423 may be limited to a gap having a width dl between one side end portion of the wing portion 431 and the other side end portion adjacent thereto even when the communication line 400 is bent or shaken by an external impact.

Further, referring to FIG. 4, the cover portion 450 may be formed to extend from an end portion of the second rib 423. For example, the cover portion 450 may extend in both side directions from the end portion of the second rib 423. Accordingly, the cover portion 450 may cover the slit 440 even when the communication line 400 is bent or shaken by an external impact.

According to the embodiment of the present disclosure, the cover portion 450 may extend to be long enough to cover the slit 440 when the communication line 400 is bent or shaken by an external impact as described above. For example, as illustrated in FIG. 4, the sum of a length d2 from the second rib 423 to one side end portion of the cover portion 450 and a thickness d3 of the second rib 423 may be greater than the width d1 of the slit 440. In this case, even when the second rib 423 is maximally bent due to an external impact and comes into contact with one side end portion of the wing portion 430, the cover portion 450 may cover the slit 440.

Meanwhile, in FIG. 4, although the rib 420, the wing portion 431, and the cover portion 450 are illustrated as being provided as a plurality of ribs 420, a plurality of wing portions 431, and a plurality of cover portions 450, respectively, two ribs 420, one wing portion 431, and one cover portion 450 may be formed. This will be described with reference to FIG. 5.

FIG. 5 is a cross-sectional view of a communication line in a direction perpendicular to a longitudinal direction according to yet another embodiment of the present disclosure.

Referring to FIG. 5, a communication line 500 may include a core portion 110, one first rib 521, and one second rib 523, one wing portion 531, and one cover portion 550. Further, both ends of the wing portion 531 of the communication line 500 may be spaced apart from each other to form one slit 540. In this case, as described with reference to FIG. 3, the manufacturing time and cost of the communication line 500 may be reduced, the communication line 500 may be more easily bent, and electromagnetic waves leaked from the core portion 110 may be weakened.

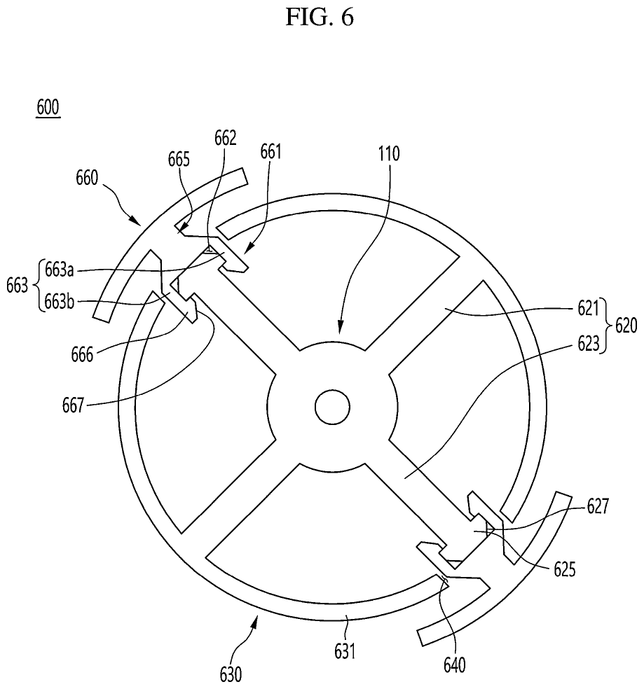

Meanwhile, the cover portion 550 may not be formed from the second rib 523, but may be detachably connected to the second rib 523. This will be described with reference to FIG. 6.

FIG. 6 is a cross-sectional view of a communication line in a direction perpendicular to a longitudinal direction according to yet another embodiment of the present disclosure.

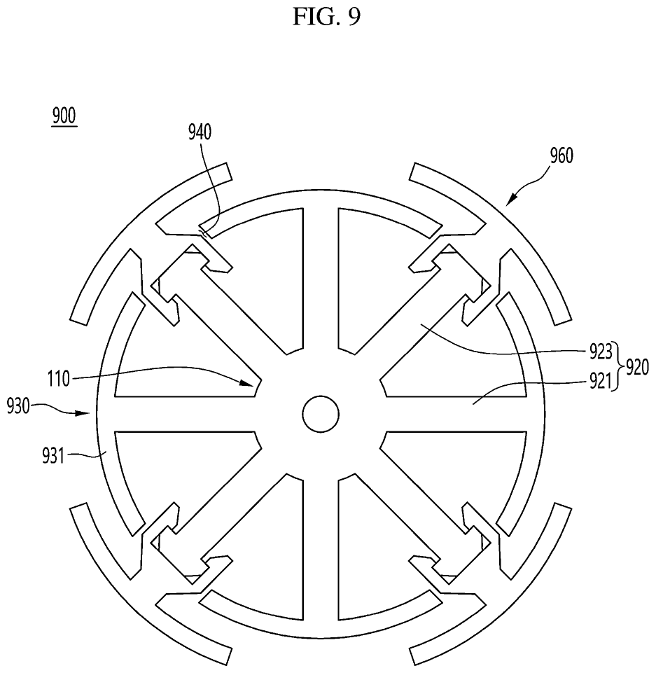

Referring to FIG. 6, a communication line 600 may include four ribs 620 composed of two first ribs 621 and two second ribs 623, and two cover portions 660. In FIG. 6, although the two cover portions 660 are illustrated as being disposed, the number of cover portions 660 is not limited thereto. This will be described below with reference to FIG. 9.

Referring to FIG. 6, the cover portion 660 may be detachably connected to the second rib 623. In this case, the cover portion 660 and the communication line 600 excluding the cover portion 660 may be manufactured separately, and thus the communication line 600 is easily manufactured and managed. Further, since the shape of the cover portion 660 or the communication line 600 excluding the cover portion 660 can be variously changed and assembled, the communication line 600 may be easily changed in various ways depending on the properties of the signal transmitted through the core portion 110 or a space in which the communication line 600 is disposed.

Meanwhile, referring to FIG. 6 the cover portion 660 may further include a body portion 665 that extends in a direction in which the second rib 623 extends from the coupling portion 661.

Referring to FIG. 6, a head portion 625 having a thickness greater than a thickness of the second rib 623 may be formed at an end portion of the second rib 623. For example, the head portion 625 may be formed such that the end portion of the second rib 623 protrudes in both side directions. Further, a coupling portion 661 for coupling with the head portion 625 may be formed on the cover portion 660. Further, the coupling portion 661 may include an accommodation space 662 in which the head portion 625 is accommodated, and two fixing portions 663 each having protrusions 666 formed in directions facing each other to fix the accommodated head portion 625. Accordingly, the cover portion 660 may accommodate the head portion 625 and be firmly fastened to the second rib 623, and thus the communication line 600 may be structurally strong.

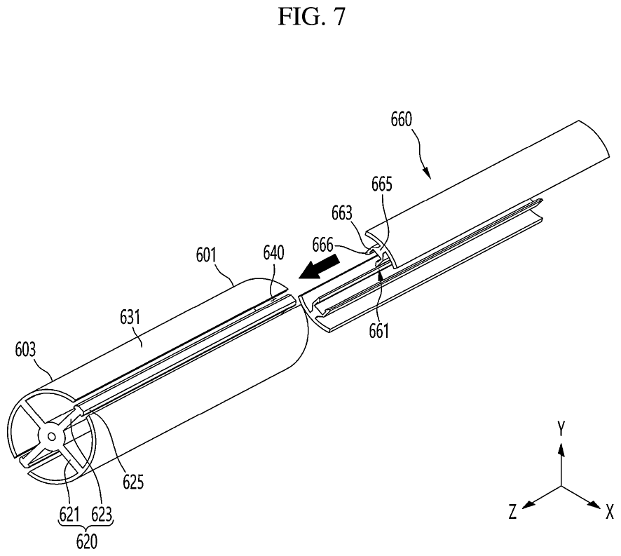

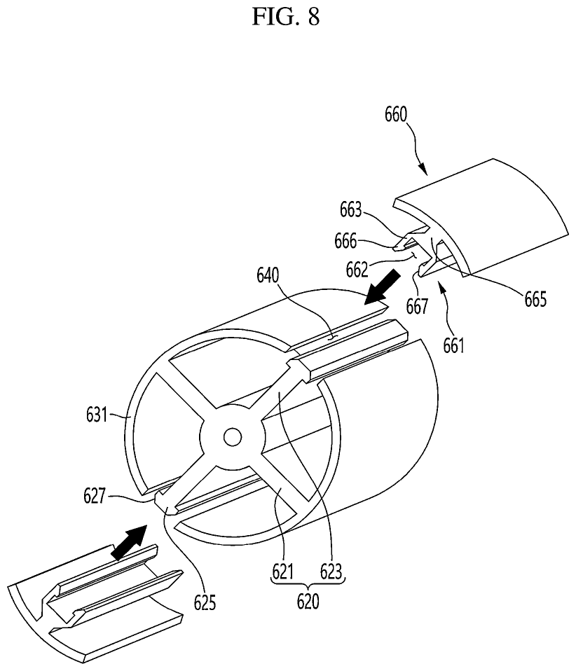

Meanwhile, the communication line 600 disclosed in FIG. 6 may be assembled in various ways. This will be described with reference to FIGS. 7 and 8.

FIG. 7 is a view for describing the cover portion of the communication line of FIG. 6 that is slid in the longitudinal direction and coupled to the second rib. FIG. 8 is a view for describing the cover portion of the communication line of FIG. 6 that is inserted from an outer side of a shielding portion and coupled to the second rib.

Referring to FIG. 7, the cover portion 660 may be slid in the longitudinal direction and coupled to the second rib 623 while the head portion 625 is accommodated in the accommodation space 662 and fixed by the two fixing portions 663. Specifically, on one end 601 of the communication line, the head portion 625 may be accommodated in the accommodation space 662, the accommodated head portion 625 may be fixed by the two fixing portions 663, and then the cover portion 660 may be slid to the other end 603 of the communication line in the longitudinal direction and coupled to the second rib 623. Here, the longitudinal direction may be a Z-axis direction illustrated in FIG. 7.

As described above, when the cover portion 660 is slid and coupled to the second rib 623, no component is subject to excessive force or elastic deformation during the coupling process, and thus the lifetime of the cover portion 660 may be increased.

Meanwhile, the cover portion 660 may be inserted from the outer side of the shielding portion 630 and coupled to the second rib 623. Referring to FIG. 8, inclined surfaces 627 and 667 may be formed on edges of the protrusion 666 and the head portion 625, respectively. Meanwhile, in FIG. 8, although the inclined surfaces 627 and 667 are disclosed as being formed on the edges at both sides of two protrusions 666 and the head portion 625, the formation location and number of inclined surfaces 627 and 667 are not limited thereto. In the present embodiment, the two fixing portions 663 may be made of a flexible material. Alternatively, the entire cover portion 660 may be made of a flexible material.

Referring to FIG. 8, the two fixing portions 663 may be elastically deformed in opposite directions by the inclined surfaces 627 and 667 when the head portion 625 is inserted toward the accommodation space 662. Specifically, as the head portion 625 is inserted from an outside of the shielding portion 630 toward the accommodation space 662, force may be applied to each of the two fixing portions 663 at the inclined surfaces 627 and 667, and the two fixing portions 663 may be elastically deformed in opposite directions by this force.

Thereafter, when the head portion 625 is fully accommodated in the accommodation space 662, each of the two fixing portions 663 is no longer subject to force by the head portion 625 and thus may be elastically recovered. Accordingly, since the head portion 625 is fixed by the protrusions 666 so as not to be separated from the accommodation space 662, the cover portion 660 may be coupled to the second rib 623. That is, the cover portion 660 and the second rib 623 may be coupled in a snap-fit manner.

According to the above-described embodiment, even when the length of the communication line 600 is long, the cover portion 660 may be pressed and inserted toward the slit 640 and simply fastened to the second rib 623, and thus the communication line 600 may be more easily assembled.

Meanwhile, in FIGS. 6 to 8, although two cover portions 660 are illustrated, the number of cover portions 660 is not limited thereto. This will be described with reference to FIG. 9.

FIG. 9 is a cross-sectional view of a communication line in a direction perpendicular to a longitudinal direction according to yet another embodiment of the present disclosure.

Referring to FIG. 9, a communication line 900 may include a core portion 110, eight ribs 920 including four first ribs 921 and four second ribs 923, four wing portions 931, and four cover portions 960. Further, four slits 940 may be formed in the communication line 900. The four cover portions 960 disclosed in FIG. 9 may also be coupled to the second ribs 923 by being slid in a longitudinal direction or by being inserted into an accommodation space through the slits 940 in a snap-fit manner, similar to the cover portion 660 disclosed in FIGS. 6 to 8.

Meanwhile, a communication system 1000 may be constructed using communication line 100. This will be described with reference to FIG. 10.

FIG. 10 is a view for describing a communication system using a communication line according to an embodiment of the present disclosure. A communication line 100 disclosed in FIG. 10 may be the same as the communication line 100 disclosed in FIGS. 1 and 2. However, this is only illustrated to describe one embodiment, and the communication lines 100, 300, 400, 500, 600, and 900 according to various embodiments of the present disclosure may be installed in the communication system 1000. Further, in FIG. 10, although a transmitter 1090 is illustrated as being disposed to be spaced apart from the communication line 100, this is for ease of description, and in some cases, the transmitter 1090 may come into contact with the communication line 100.

Referring to FIG. 10, the communication system 1000 may include the communication line 100 and the transmitter 1090 that outputs an electromagnetic wave signal toward the communication line 100. The transmitter 1090 may be a transceiver capable of not only outputting an electromagnetic wave signal but also receiving an electromagnetic wave signal. For example, the transmitter 1090 may be an antenna capable of transmitting or receiving an electromagnetic wave signal. According to the above-described embodiment, the communication system 1000 may transmit an electromagnetic wave signal output from the transmitter 1090 from one end 101 of the communication line 100 to the other end 103 or from the other end 103 to the one end 101.

Further, the transmitter 1090 according to the embodiment of the present disclosure may be a coupler that has an antenna therein and is connected to a board. For example, the antenna may be disposed inside the transmitter 1090, and the transmitter 1090 may be coupled to a board so that the antenna, which is surface mounted on a surface of the board or separately disposed on the board, is located inside the transmitter 1090. Alternatively, the antenna mounted on the surface of the board may radiate electromagnetic waves from the outside of the transmitter 1090, and the transmitter 1090 may guide the electromagnetic waves so as to be radiated toward the communication line 100. Meanwhile, the transmitter 1090 may have a cylindrical shape as illustrated in FIG. 10, but the shape of the transmitter 1090 is not limited thereto.

Meanwhile, referring to FIG. 10, in the communication system 1000, the communication line 100 may be installed such that a direction in which ribs 120 extend from a core portion 110 is misaligned with a horizontal polarization direction or a vertical polarization direction of an electromagnetic wave signal so that the electromagnetic wave signal does not leak to an outside of the communication line 100. Here, the electromagnetic wave is composed of an electric field (E-field) and a magnetic field (H-field) that oscillate perpendicularly to each other, and the horizontal polarization direction of the electromagnetic wave signal may be one of an electric field oscillation direction or a magnetic field oscillation direction, and the vertical polarization direction may be the other.

For example, as illustrated in FIG. 10, the communication line 100 may be disposed in a longitudinal direction with being rotated 45° around a central axis. In this case, the extension direction of the rib 120 may be a direction forming a character X, and the horizontal polarization direction or the vertical polarization direction of the electromagnetic wave signal radiated from the transmitter 1090 may be a direction forming a cross (+). That is, the extension direction of the rib 120 may form a 45° angle with the horizontal polarization direction or the vertical polarization direction of the electromagnetic wave signal. In this case, since the extension direction of the rib 120 and the polarization direction of the electromagnetic wave signal can be maximally misaligned, the phenomenon in which the electromagnetic wave signal transmitted through the core portion 110 leaks out of the communication line 100 can be minimized. Accordingly, a signal attenuation degree according to a length of the communication line 100 can also be significantly reduced.

According to one of the solutions of the present disclosure, a communication line can prevent a problem such as signal quality degradation or increased signal loss rate by preventing external dust or foreign matter from being attached to a portion through which a signal is transmitted.

According to one of the solutions of the present disclosure, a communication line can be easily bent, and easily connect devices to each other even in a narrow or complex space.

According to one of the solutions of the present disclosure, a communication line can prevent a problem such as signal quality degradation or increased signal loss rate by preventing the formation of a gap through which dust or foreign matter can enter an inside of the communication line even when the communication line is bent.

According to one of the solutions of the present disclosure, in a communication line or a communication system, an electric field leaking to the outside can be significantly reduced.

The effects obtainable in the present disclosure are not limited to the above-described effects and other effects that are not described may be clearly understood by those skilled in the art from the above detailed descriptions.

While embodiments of the present disclosure have been described in more detail with reference to the accompanying drawings, the present disclosure is not necessarily limited to these embodiments, and various modifications may be made in the present disclosure without departing from the spirit and scope of the present disclosure. Accordingly, the embodiments disclosed in the present disclosure are not intended to limit the technical idea of the present disclosure but to explain it, and the scope of the technical idea of the present disclosure is not limited by these embodiments. Therefore, it should be understood that the embodiments described above are exemplary in all respects and not restrictive. The scope of the present disclosure should be interpreted by the appended claims and encompasses all modifications and equivalents that fall within the scope of the appended claims.

What is claimed is:

1. A communication line comprising:
a core portion that extends in a longitudinal direction and has a circular cross section;
one or more ribs formed to extend from an outer surface of the core portion;
a shielding portion that is connected to the rib, is formed to surround the core portion, and has at least one slit formed in the longitudinal direction; and
a cover portion configured to cover the slit.

2. The communication line of claim 1, wherein the cover portion is disposed to be spaced apart from the slit on an outer side of the shielding portion.

3. The communication line of claim 2, wherein the shielding portion includes a wing portion formed to extend in a circumferential direction of the core portion from at least one of the ribs, and
a portion of the cover portion is disposed to overlap a portion of the wing portion in a radial direction of the core portion.

4. The communication line of claim 3, wherein the wing portion is formed to extend in both side directions from the rib, and
both ends of the wing portion are spaced apart from each other to form a slit.

5. The communication line of claim 3, wherein one end of the wing portion formed to extend from any one of the ribs and one end of the wing portion formed to extend from an adjacent rib are spaced apart from each other to form a slit.

6. The communication line of claim 3, wherein the cover portion protrudes from a portion of the wing portion, covers an adjacent slit, and extends while being bent.

7. The communication line of claim 3, wherein the ribs include:
a first rib from which the wing portion is formed; and
a second rib from which the cover portion is disposed.

8. The communication line of claim 7, wherein the second rib protrudes to pass through the slit, and
the cover portion is formed to extend from an end portion of the second rib.

9. The communication line of claim 8, wherein a sum of a length from the second rib to one side end portion of the cover portion and a thickness of the second rib is greater than a width of the slit.

10. The communication line of claim 7, wherein the cover portion is detachably connected to the second rib.

11. The communication line of claim 10, wherein a head portion having a thickness greater than a thickness of the second rib is formed at an end portion of the second rib,
a coupling portion for coupling with the head portion is formed on the cover portion, and
the coupling portion includes:
an accommodation space in which the head portion is accommodated when the coupling portion is coupled to the second rib; and
two fixing portions each having protrusions formed in directions facing each other to fix the accommodated head portion.

12. The communication line of claim 11, wherein the cover portion is slid in the longitudinal direction and coupled to the second rib while the head portion is accommodated in the accommodation space and fixed by the two fixing portions.

13. The communication line of claim 11, wherein inclined surfaces are formed at both sides of the head portion,
each of the two fixing portions is elastically deformed in opposite directions by the inclined surfaces when the head portion is inserted toward the accommodation space, and
the cover portion is coupled to the second rib as each of the two fixing portions is elastically recovered.

14. The communication line of claim 1, wherein the core portion, the ribs, the shielding portion, and the cover portion are formed to extend in the same direction and are made of the same flexible dielectric material.

15. A communication system comprising:
the communication line of claim 1; and
a transmitter configured to output an electromagnetic wave signal toward the communication line.

16. The communication system of claim 15, wherein the communication line is installed such that a direction in which ribs extend from a core portion is misaligned with a horizontal polarization direction or a vertical polarization direction of an electromagnetic wave signal so that the electromagnetic wave signal does not leak to an outside of the communication line.
